(19) United States
(12) Patent Application Publication
(10) Pub. No.: US 2024/0080573 A1
(43) Pub. Date: Mar. 7, 2024

(54) IN-PLANE PREPROCESSOR AND MULTIPLANE HARDWARE NEURAL NETWORK

(71) Applicants: The Trustees of Princeton University, Princeton, NJ (US); Universal Display Corporation, Ewing, NJ (US)

(72) Inventors: Simon Bilodeau, Princeton, NJ (US); Eli A. Doris, Princeton, NJ (US); Michael Hack, Carmel, CA (US); Paul Prucnal, Princeton, NJ (US)

(21) Appl. No.: 18/461,801

(22) Filed: Sep. 6, 2023

Related U.S. Application Data
(60) Provisional application No. 63/374,655, filed on Sep. 6, 2022.
(60) Provisional application No. 63/374,661, filed on Sep. 6, 2022.

(51) Int. Cl. H04N 23/80; H04N 23/65

(52) U.S. Cl. CPC H04N 23/80; H04N 23/651

(57) ABSTRACT

Convolutional neural networks have, over the last decade, risen to state-of-the-art for computer vision tasks such as image classification. Oftentimes these are implemented on specialized digital processors, which target high throughput operation. This is efficient when analyzing batches of images loaded from memory but is lacking when analyzing freshly-captured images on a sensor. Latency is an issue since image acquisition alone can take as long as the processing. Second, streams of images captured from sensors can result in highly redundant processing if only specific signatures needs to be recognized, leading to a high amount of wasted power. Disclosed is a way to perform convolutional processing on the image plane where the image is captured, which allows the device to only complete readout and processing when required. This reduces latency and power consumption, enabling new applications such as augmented reality and edge processing that are not possible with current technology.

### CROSS-REFERENCE TO RELATED APPLICATIONS

This application claims priority to U.S. provisional application No. 63/374,655 filed on Sep. 6, 2022, and to U.S. provisional application No. 63/374,661 filed on Sep. 6, 2022, each incorporated herein by reference in their entirety.

### BACKGROUND OF THE INVENTION

Neural networks, and particularly convolutional neural networks, have, over the last decade, risen to state-of-the-art for computer vision tasks such as image classification. Oftentimes these are implemented on specialized digital processors, which target high throughput operation. This is efficient when analyzing batches of images loaded from memory but is lacking when analyzing freshly-captured images on a sensor. First, latency is an issue, since image acquisition alone and/or read out can be as long as the processing, and high digital system throughputs come at the expense of latency via batching. Second, streams of images captured from sensors can result in highly redundant processing, and accordingly highly inefficient operation, if only specific signatures need to be recognized but every image is completely read out and reanalyzed. Additionally, the high data rates required to send image data to a specialized digital processors can consume large amounts of power.

Neural processing on an image's acquisition plane is an old topic, but neural networks have only recently experienced an explosion of success due to both practical issues and bottlenecks in traditional Von Neumann computing architectures.

One instantiation of a neural network is the cellular neural network, where smart nodes on a plane communicate with “neighbors”. These networks have applications such as image processing and solving dynamical systems. The most energy-efficient and fast instantiation of these networks is in analog electronics. There, “neighbors” is typically restricted to physical nearest neighbors on a single plane due to topological wiring restrictions and the size of synaptic elements.

Thus there is a need in the art for improved neural networks, multiplane hardware neural networks, and related components.

### SUMMARY OF THE INVENTION

Some embodiments of the invention disclosed herein are set forth below, and any combination of these embodiments (or portions thereof) may be made to define another embodiment.

In one aspect, a device comprises a plurality of optically connected networked smart pixels positioned in one or more planes, one or more imaging sensors connected to at least a portion of the smart pixels, and wherein the device is configured to perform processing on the plane where an image is captured.

In one embodiment, the device is configured as a wake-up mechanism for a processor interpreting images from a camera.

In one embodiment, the device is configured as an event camera to determine when the processor should be energized from stand-by mode into operational mode to provide real time interpretation of the camera image.

In one embodiment, the device is configured to perform completed reduced readout from the camera and processing when required to reduce latency by 25% to 99.9% and power consumption by 25% to 99.9%.

In one embodiment, the smart pixels evolve over time based on the values of other pixels the smart pixel is connected to.

In one embodiment, the evolution of the smart pixels is driven by local photocurrents and other input signals.

In one embodiment, the device is configured for image capture and processing and includes an imaging lens or a camera.

In one embodiment, the device is configured to perform convolutional, non-convolutional, and/or standard processing on the image plane where the image is captured.

In one embodiment, the device is configured as a wake-up mechanism for an edge processor interpreting images from a camera.

In one embodiment, the device is further configured to reduce a time that the edge processor utilizes to interpret the images by 50% to 99.9%.

In one embodiment, the device is configured as an event camera to determine when a processor should be energized from stand-by mode into operational mode to provide real time interpretation of the camera image.

In one embodiment, the device is configured to perform completed reduced readout and processing when required to reduce latency by 25% to 99.9% and power consumption by 25% to 99.9%.

In one embodiment, a subset of the smart pixels is reserved for non-image processing tasks comprising triggering logic.

In one embodiment, the smart pixels comprise an output configured to be conditioned by one or more received inputs, wherein the smart pixels evolve over time based on the values of other pixels the smart pixel is connected to, wherein the evolution of the smart pixels is driven by local photocurrents and other input signals, and wherein a subset of the smart pixels is reserved for non-image processing tasks such as triggering logic.

In one embodiment, the device is configured to reduce the amount of readout data required by 25% to 99.9% compared to that acquired by the image sensor without the preprocessor.

In one embodiment, the device further comprises a motion sensor, a chemical sensor, an audio sensor, a position sensor, a pressure sensor, a temperature sensor, a force sensor, a vibration sensor, or a humidity sensor.

In another aspect, a system comprises the device as described above, and a computing system communicatively connected to the device, comprising a processor and a non-transitory computer-readable medium with instructions stored thereon, which when executed by a processor, perform steps comprising performing convolutional, non-convolutional, and/or standard processing on the image plane where the image is captured. In some embodiments, the computing system is separate from the preprocessor device and/or system. In some embodiments, the computing system is embedded into the preprocessing and/or system.

In another aspect, a product comprises the device and/or system as described above, the product selected from the group consisting of a flat panel display, a curved display, a computer monitor, a computer, a medical monitor, a television, a billboard, a light for interior or exterior illumination and/or signaling, a heads-up display, a fully or partially transparent display, a flexible display, a rollable display, a foldable display, a stretchable display, a laser printer, a telephone, a mobile phone, a tablet, a phablet, a personal digital assistant (PDA), a wearable device, a laptop computer, a digital camera, a camcorder, a viewfinder, a micro-display, a 3-D display, a virtual reality or augmented reality display or device, a vehicle, a video wall comprising multiple displays tiled together, a theater or stadium screen, a light therapy device, a camera, an imaging device, and a sign.

In another aspect, a method comprises providing the preprocessor system as described above, and performing convolutional, non-convolutional, and/or standard processing on the image plane where the image is captured.

In one embodiment, the processing comprises local processing of data where it is acquired before readout.

In one embodiment, the method further comprises offloading general processing to an external processor when a specific signature is detected.

In one embodiment, the method further comprises offloading partially processed data to reduce later processing steps.

In one embodiment, the method further comprises offloading partially processed data to reduce the amount of data to transfer.

In another aspect, a preprocessor manufacturing method comprises manufacturing a plurality of networked smart pixels on an image plane.

In one embodiment, the manufacturing is performed via spin coating or deposition.

In another aspect, a low power video system including an edge processor and camera capable of real time interpretation of a video image captured by the camera and an in-plane neural network processor built into the camera capable of performing real time preprocessing of the video signal to provide a fast response time and low latency signal within 1 is to 10 ms to select when the edge processor is energized.

In one embodiment, the edge processor is in stand-by mode when not selected by the preprocessor.

In another aspect, a device comprises a plurality of optically connected networked smart pixels positioned in a multiplane configuration, wherein the smart pixels comprise an output configured to be conditioned by one or more received inputs, and a plurality of smart nodes communicatively connected to the plurality of networked smart pixels.

In one embodiment, the smart pixels evolve over time based on the values of other pixels the smart pixel is connected to.

In one embodiment, the evolution of the smart pixels is driven by local photocurrents.

In one embodiment, the device is configured for image processing.

In one embodiment, the smart pixels are configured to implement different network topologies by formatting arbitrary input data as a spatially-resolved optical intensity image.

In one embodiment, non-image inputs are directly provided to the smart pixels.

In one embodiment, at least a portion of the smart pixels comprise light-emitting smart pixels configured to display an image.

In one embodiment, at least a portion of the smart nodes comprise optical emitters and non-planar synaptic elements.

In another aspect, a system comprises the device as described above, and a computing system communicatively connected to the device, comprising a processor and a non-transitory computer-readable medium with instructions stored thereon, which when executed by a processor, perform steps comprising performing processing of physically-separated inputs.

In one embodiment, wherein the system comprises a multiplane neural network.

In one embodiment, the neural network is configured to perform stereoscopic image processing or processing images received from multiple independent cameras.

In one embodiment, the neural network is configured to perform any image processing tasks where multiple physically-separated cameras are required to cover different viewing angles.

In one embodiment, the system comprises a cellular neural network with smart nodes on a plane.

In one embodiment, the cellular network has arbitrary neighborhoods.

In one embodiment, the arbitrary neighborhoods include nearest neighbors or beyond nearest neighbors on a single plane or on different planes.

In one embodiment, outputs of the smart pixels are routed to conventional processors via regular image planes or other optical communication links.

In one embodiment, the system is configured to perform processing of physically-separated inputs.

In another aspect, a product comprises the system and/or device as described above, the product selected from the group consisting of a flat panel display, a curved display, a computer monitor, a computer, a medical monitor, a television, a billboard, a light for interior or exterior illumination and/or signaling, a heads-up display, a fully or partially transparent display, a flexible display, a rollable display, a foldable display, a stretchable display, a laser printer, a telephone, a mobile phone, a tablet, a phablet, a personal digital assistant (PDA), a wearable device, a laptop computer, a digital camera, a camcorder, a viewfinder, a micro-display, a 3-D display, a virtual reality or augmented reality display or device, a vehicle, a video wall comprising multiple displays tiled together, a theater or stadium screen, a light therapy device, a camera, and imaging device, and a sign

In another aspect, a method comprises providing the system as described above, and performing processing of physically-separated inputs.

In another aspect, a processor manufacturing method comprises manufacturing a plurality of networked smart pixels in a multiplane configuration.

In one embodiment, the manufacturing is performed via spin coating or deposition.

In one embodiment, the device comprises a processor and/or preprocessor.

In one embodiment, the system comprises a processor and/or preprocessor system.

In one embodiment, the method comprises a processing and/or preprocessing method.

### BRIEF DESCRIPTION OF THE DRAWINGS

The foregoing purposes and features, as well as other purposes and features, will become apparent with reference to the description and accompanying figures below, which are included to provide an understanding of the invention and constitute a part of the specification, in which like numerals represent like elements, and in which:

FIG. 1 depicts an exemplary neural preprocessor device in accordance with some embodiments.

FIGS. 2A-2B depict exemplary multiplane neural preprocessor devices in accordance with some embodiments.

FIG. 3 depicts an exemplary computing environment in which aspects of the invention may be practiced.

### DETAILED DESCRIPTION OF THE INVENTION

It is to be understood that the figures and descriptions of the present invention have been simplified to illustrate elements that are relevant for a clearer comprehension of the present invention, while eliminating, for the purpose of clarity, many other elements found in systems and methods of in-plane preprocessors. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, exemplary methods and materials are described.

As used herein, each of the following terms has the meaning associated with it in this section.

The articles “a” and “an” are used herein to refer to one or to more than one (i.e., to at least one) of the grammatical object of the article. By way of example, “an element” means one element or more than one element.

“About” as used herein when referring to a measurable value such as an amount, a temporal duration, and the like, is meant to encompass variations of ±20%, ±10%, ±5%, ±1%, and ±0.1% from the specified value, as such variations are appropriate.

Ranges: throughout this disclosure, various aspects of the invention can be presented in a range format. It should be understood that the description in range format is merely for convenience and brevity and should not be construed as an inflexible limitation on the scope of the invention. Where appropriate, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, and 6. This applies regardless of the breadth of the range.

As described throughout this application “smart pixel” and “smart node” may be used interchangeably to refer to a single element, or may described separated elements, as one skilled in the art would understand. Exemplary smart pixels may be found in U.S. Patent Application No. 20210192330 and U.S. Patent Application No. 20230157061, each hereby incorporated herein by reference in their entirety.

In a sensor-readout-processor-decision pipeline, latency comes from both readout from the sensor to the processor (in general, with an intermediate step in memory), in addition to the processing itself. This latency is especially severe for a 2D planar sensor where, typically, the N² pixels are read-out N at a time in a through active matrix addressing, for example. Furthermore, in typical situations, sensed information is highly redundant, with decisions of interest comprising only a small fraction of the total information that can be measured, read out, and processed.

Therefore, it is highly advantageous to have a device where only interesting signals are readout, and where readout data is as minimal as possible to minimize, readout, processing latency, and power consumption.

The result is a need for a preprocessor, which can perform some local processing of data where it is acquired before readout. This preprocessor only offloads more general processing to an external processor if a specific signature is detected instead of offloading all sensed data at all times. It furthermore, in some embodiments, does not offload raw data, but instead offloads partially processed data, which cuts down on later processing steps and/or amount of data to transfer.

Referring now in detail to the drawings, in which like reference numerals indicate like parts or elements throughout the several views, in various embodiments, presented herein are in-plane preprocessor devices, systems and methods.

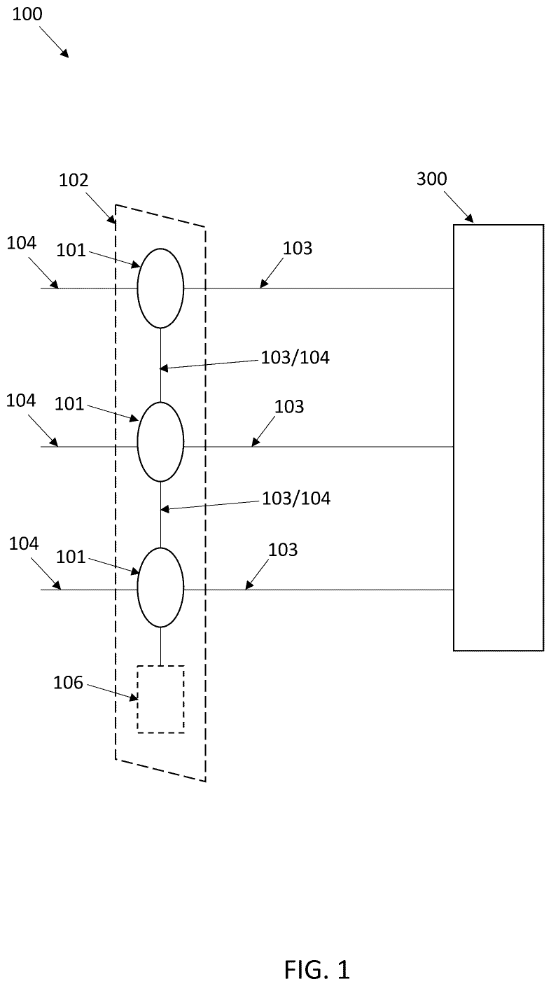

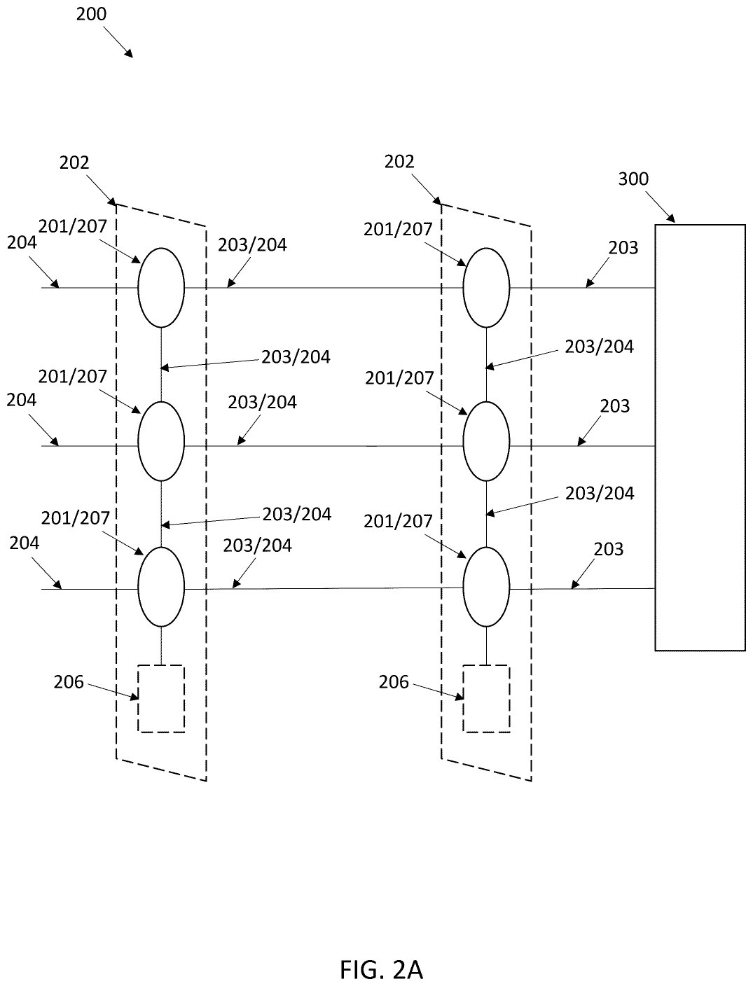

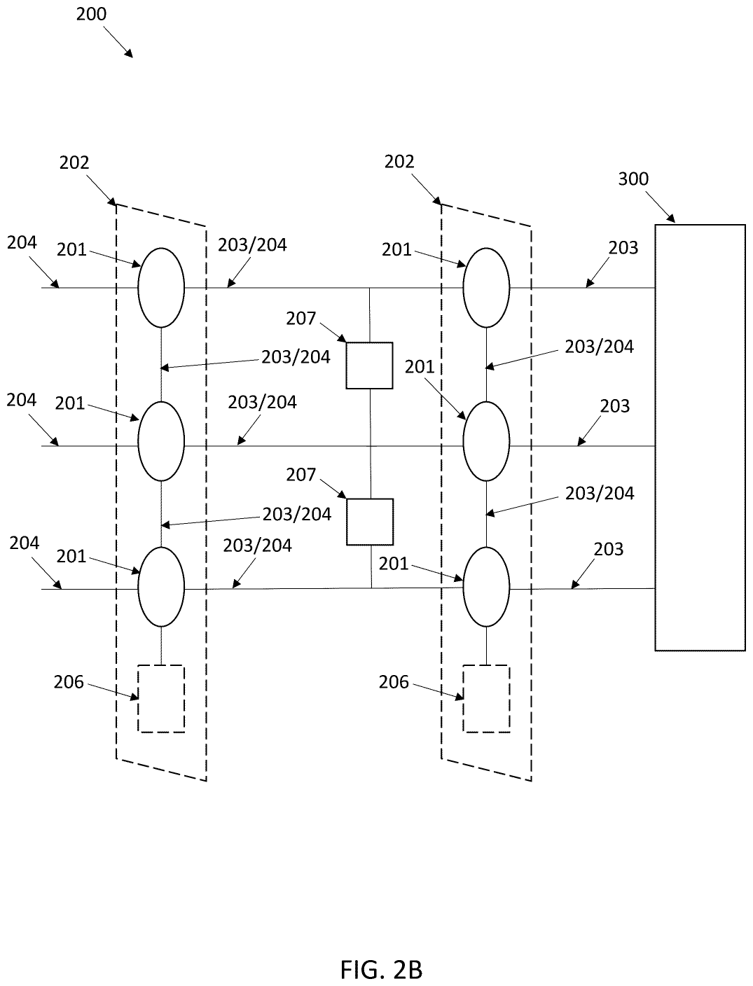

As shown in FIGS. 1, 2A and 2B, in some embodiments, the invention comprises a neural processor or pre-processor including smart pixels whose evolution is driven by local photocurrents and other input signals. A smart pixel in a display or image sensor is one where the pixel has more functionality or intelligence than a standard pixel which just produces an image based solely on the input video signal or the sensor information from an image sensor. Further, this could be based on other inputs to the pixel from the outside world or neighboring pixels, embedded sensors in the pixel, and/or memory or computation that can be performed directly in each pixel.

While a natural use case described here is image processing, in principle any neural processing task could be performed by having the smart pixels implement different network topologies and by formatting arbitrary input data as spatially-resolved optical intensity (an “image”). An exemplary possible use for the invention is as a way of adding intelligence to a camera so that a conventional camera could be used as an event camera to determine when a processor should be energized from stand-by mode into operational mode to provide real time interpretation of the camera image. In other words, it could act as a wake-up mechanism for an edge processor interpreting images from a camera. This can allow the overall system to operate at much lower power consumption.

In some embodiments, the invention provides a way to perform convolutional, non-convolutional, and/or standard processing on the image plane where the image is captured, which allows the device to only complete reduced readout and processing when required. This reduces latency and power consumption, enabling new applications such as augmented reality and edge processing that are not possible with current technology.

Referring now to FIG. 1, an exemplary neural preprocessor device 100 is shown. In some embodiments the device 100 includes a plurality of optically connected networked smart pixels 101 positioned on an image plane 102. In some embodiments, the plurality of optically connected networked smart pixels 101 may comprises, be part of, or at least an element of, a camera or any other suitable imaging device. In some embodiments, the smart pixels 101 comprise an output 103 configured to be conditioned by one or more received inputs 104. In some embodiments, the smart pixels 101 evolve over time based on the values of other pixels the smart pixel is connected to. In some embodiments, the evolution of the smart pixels 101 is driven by local photocurrents and other input signals 104. In some embodiments, the device 100 is configured to perform convolutional, non-convolutional, and/or standard processing on the image plane 102 where the image is captured. In some embodiments, the device 100 is configured for image capture and processing.

In some embodiments, the device 100 is configured as a wake-up mechanism for an edge processor interpreting images from the camera. In some embodiments, the device 100 is configured to reduce the time that the edge processor utilizes to interpret the images by about 50% to 99.9%. In some embodiments, the device 100 is configured as an event camera to determine when a processor should be energized from stand-by mode into operational mode to provide real time interpretation of the camera image. In some embodiments, the device 100 is configured to perform completed reduced readout and processing when required to reduce latency by 25% to 99.9% and/or power consumption by 25% to 99.9%. In some embodiments, a subset of the smart pixels 101 is reserved for non-image processing tasks comprising triggering logic. In some embodiments, trigger events can be based on motion and/or recognition of specific features in the captured visual image. In some embodiments, the device 100 is configured to reduce the amount of readout required compared to that acquired by the camera alone by 25% to 99.9%.

In some embodiments, similar to typical neural networks, neurons (i.e. smart pixels 101) can be configured with a nonlinear input-output relationship such that they only produce significant output if the correct set of inputs are given. In some embodiments, this can be thought of as “pattern matching,” where a neuron's output corresponds to the presence or absence of a specific pattern. If used for triggering, this means a specific pattern will cause a system output. Patterns can be image features, total signal level, or other suitable metrics.

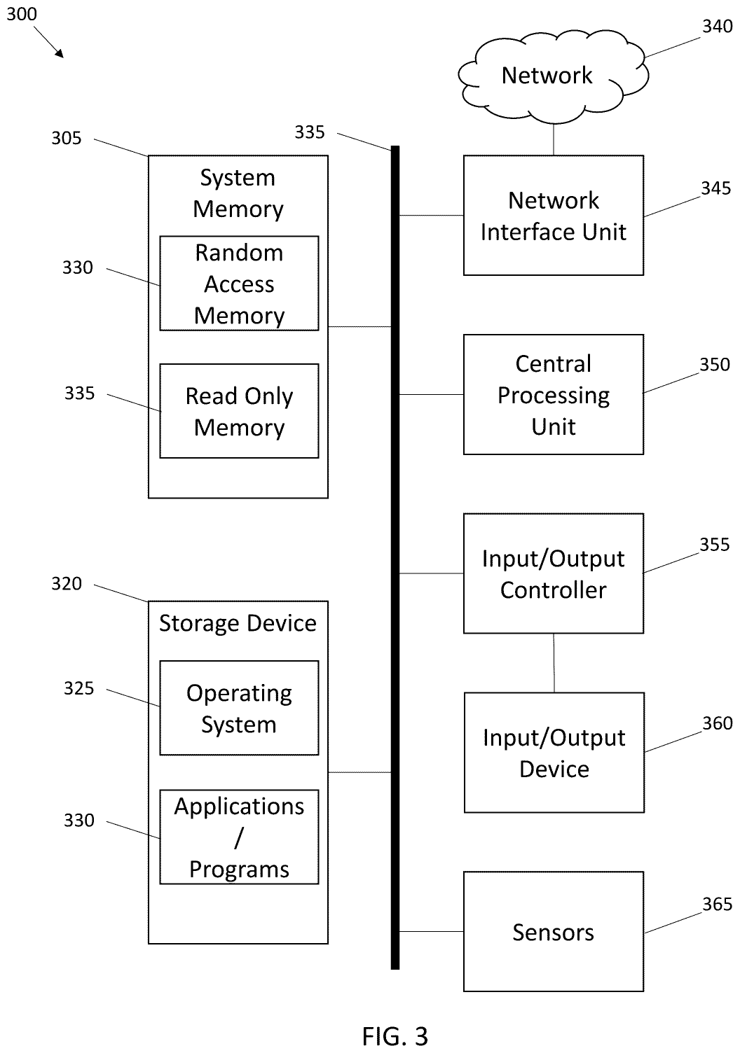

In some embodiments, a neural preprocessor system comprises the neural preprocessor device 100 and a computing system 300 communicatively connected to neural preprocessor device 100, comprising a processor and a non-transitory computer-readable medium with instructions stored thereon, which when executed by a processor, perform steps comprising performing convolutional, non-convolutional, and/or standard processing on the image plane where the image is captured. An exemplary computing system 300 is described below and shown in FIG. 3.

In some embodiments, a product comprises the neural preprocessor device 100. In some embodiments, the product comprises a flat panel display, a curved display, a computer monitor, a computer, a medical monitor, a television, a billboard, a light for interior or exterior illumination and/or signaling, a heads-up display, a fully or partially transparent display, a flexible display, a rollable display, a foldable display, a stretchable display, a laser printer, a telephone, a mobile phone, a tablet, a phablet, a personal digital assistant (PDA), a wearable device, a laptop computer, a digital camera, a camcorder, a viewfinder, a micro-display, a 3-D display, a virtual reality or augmented reality display or device, a vehicle, a video wall comprising multiple displays tiled together, a theater or stadium screen, a light therapy device, a camera, an imaging device, a sign, and any other suitable product or combination thereof.

In some embodiments, a neural preprocessing method comprises providing the system or device 100, and performing convolutional, non-convolutional, and/or standard processing on the image plane where the image is captured. In some embodiments, the processing comprises local processing of data where it is acquired before readout. In some embodiments, the method further includes offloading general processing to an external processor when a specific signature is detected, offloading partially processed data to reduce later processing steps, and/or offloading partially processed data to reduce the amount of data to transfer.

In some embodiments, A low power video system comprises an optional edge processor 106, a camera capable of real time interpretation of a video image captured by the camera, and an in-plane neural network processing device 100 built into the camera configured to perform real time preprocessing of the video signal to provide a fast response time and low latency signal on the order of microseconds to select when the edge processor is energized. In some embodiments, the edge processor 106 is in stand-by mode when not selected by the preprocessor device 100.

Referring now to FIGS. 2A-2B, an exemplary multiplane neural preprocessor device 200 is shown. In some embodiments, the device 200 includes a plurality of optically connected networked smart pixels 201 positioned in a multiplane configuration 202. In some embodiments, the plurality of optically connected networked smart pixels 201 may comprise, be part of, or at least an element of, a camera or any other imaging device. In some embodiments, one or more optional edge processors 206 are also included on the planes 202. In some embodiments, the smart pixels 201 comprise an output 203 configured to be conditioned by one or more received inputs 204. In some embodiments (FIG. 2A), at least a portion of the smart pixels 201 can also be defined as smart nodes 207. In some embodiments (FIG. 2B), a plurality of smart nodes 207 are separate from and optically connected to the plurality of networked smart pixels 201. In some embodiments, a combination of at least a portion of the smart pixels 201 can also be defined as smart nodes 207 and a plurality of smart nodes 207 are separate from and optically connected to the plurality of networked smart pixels 201 can be utilized.

In some embodiments, the smart pixels 201 evolve over time based on the values of other pixels and smart nodes the smart pixel is connected to. In some embodiments, the evolution of the smart pixels 201 is driven by local photocurrents. In some embodiments, the device 200 is configured for image processing.

In some embodiments, the smart pixels 201 are configured to implement different network topologies by formatting arbitrary input data 204 as a spatially-resolved optical intensity image. In some embodiments, non-image inputs 204 are directly provided to the smart pixels 201.

In some embodiments, at least a portion of the smart pixels 201 comprise light-emitting smart pixels configured to display an image. In some embodiments, at least a portion of the smart nodes 207 comprise optical emitters and/or non-planar synaptic elements.

In some embodiments, a neural preprocessor system comprises the neural preprocessor device 200, and a computing system 300 communicatively connected to neural preprocessor device 200, comprising a processor and a non-transitory computer-readable medium with instructions stored thereon, which when executed by a processor, perform steps comprising performing processing of physically-separated inputs on the neural processor device. In some embodiments, the system comprises a multiplane neural network configured to perform stereoscopic image processing or processing of images received from multiple independent cameras.

In some embodiments, the system comprises a cellular neural network with smart nodes 207 on a plane which may or may not be a plane 202 in which a portion of the smart pixels 201 are positioned. In some embodiments, the cellular neural network has arbitrary neighborhoods. In some embodiments, the arbitrary neighborhoods include nearest neighbors or beyond nearest neighbors on a single plane or on different planes. In some embodiments, the system is configured to perform neural processing of physically-separated inputs and/or other optical communication links.

In some embodiments, a product comprises the neural preprocessor device 200. In some embodiments, the product comprises a flat panel display, a curved display, a computer monitor, a computer, a medical monitor, a television, a billboard, a light for interior or exterior illumination and/or signaling, a heads-up display, a fully or partially transparent display, a flexible display, a rollable display, a foldable display, a stretchable display, a laser printer, a telephone, a mobile phone, a tablet, a phablet, a personal digital assistant (PDA), a wearable device, a laptop computer, a digital camera, a camcorder, a viewfinder, a micro-display, a 3-D display, a virtual reality or augmented reality display or device, a vehicle, a video wall comprising multiple displays tiled together, a theater or stadium screen, a light therapy device, a camera, an imaging device, a sign, and any other suitable product or combination thereof.

In some embodiments, a neural processing method comprises providing the system or device 200, and performing processing of physically-separated inputs.

In some embodiments, the analog nature of the device can, like any analog device, be a limitation if noise reduces processing accuracy. As mitigating factors, the nonlinearity in neural networks imbues them with some noise resistance and neural networks can be trained to have some intrinsic noise resistance by cascading system noise onto the input and training on noisy data.

In some embodiments, the local triggering mechanism for readout needs to be defined on a task-dependent basis. To maintain the advantage over complete readout, only a subset of the smart pixel neurons would have to be sampled and hit some condition simultaneously to trigger full readout. This would still require partial readout, but it can save considerable power compared to having a continuous full readout. Alternatively, a portion of the smart device can be reserved for non-image processing tasks (e.g. fully connected layers) to perform this triggering.

In some embodiments, the above-described devices and systems can be included in regular imagers to reduce the amount of readout required.

In some embodiments, the devices and systems are able to perform a large number of neural operations, such as multiply accumulate and thresholding, in a planar manner. In some embodiments, the smart pixels are able to both detect a signal and emit a signal, with some of the emission of each pixel being broadcast to other pixels through tunable interconnections. In some embodiments, pixel emission is conditioned on the sum of detected signals after the tunable interconnection, and hence after an initial external input acquisition, the smart pixels on the plane will evolve in time, processing the image. The use of reprogrammable interconnections means that this emulates a neural network architecture able to perform many different processing tasks. In some embodiments, even though the above-described devices and systems are focused on doing this photonically, “emission”, “detection”, and “tunable interconnections” could also be done electronically in general. In some embodiments, the above-described devices and systems are configured for in-plane neural preprocessing of information.

In some embodiments, neural preprocessing begins with an input layer. Hence, the type of preprocessing that occurs depends on the types of input available to the in-plane preprocessor. In-plane, an obvious choice is imaging, where local pixel photocurrent map to an input image.

Other sensors can be added, either globally (one sensor output being input to all nodes), or locally (each node, or a subset of nodes, having its own small sensor). For instance, motion, chemical, and audio sensors, radiation, photo sensors, or any other suitable sensors or combinations thereof may also be included.

While changes in sensor readout typically indicate that an environment has changed, it is possible to deliberately change the environment to which the sensor is exposed in order to acquire complementary information. For instance, the same imaging pixels will see different scenes if some overlying imaging optics are focused differently. In this case, neural processing having as input all or some combination of these different logical inputs can be done by adding local memory to the sensors.

After an input is acquired, the neural preprocessing can begin as described above. Some smart pixels can be allowed to receive input signals from the outside, while others only receive signals from other smart pixels (“hidden” pixels), which allows more flexibility in the types of networks to be simulated.

During processing, the tunable interconnections can be dynamically changed at every “time step” to implement arbitrarily complex tasks. For instance, a popular image recognition neural network called “YOLOv5m” has approximately 80 3×3 convolutional layers at the front end. This means that in the initial stages of processing, neurons in this network communicate their state via a weighted connection with their 8 nearest neighbors and themselves, and do so about 80 times with different weights (trained to recognize a subset of objects). Later layers combine pixel outputs differently to perform a decision over the entire image. In some embodiments, part of the smart display can be engineered to implement similar non-convolutional parts of the network, and outputting a readout trigger if there is a high probability that the target object to detect is present. Only then does the (already preprocessed) image need to leave the sensor to complete processing on an external processor.

In some embodiments, specific applications of a multiplane cellular neural network include stereoscopic image processing (for instance, extracting the disparity between image pairs to estimate depth), and any image processing tasks where multiple physically-separated (smart) cameras are required to cover different viewing angles.

In some embodiments, if the smart light-emitting pixels can also display an image, this can be used to condition a display's output based on images captured somewhere else at high speeds, since sequential readout and display drivers are bypassed.

In some embodiments, the invention uses smart nodes comprising optical emitters and non-planar synaptic elements, and as such does not suffer the above described limitations. It therefore enables a hardware instantiation of a cellular neural network with arbitrary neighborhoods, for instance beyond nearest neighbors on a single plane, or on different planes, allowing a physical realization of multiplane cellular neural networks.

Another advantage of smart pixel arrays connected at the pixel level optically is that their output can be routed to conventional processors (e.g. CPUs) via e.g. regular image planes. These can also be physically-separated and can complement any processing performed by the planes.

In some embodiments, the devices and systems described above are manufactured by various standard microfabrication and thin-film processes (spin coating, deposition, etc.).

In some embodiments, while in theory neurons broadcasting in the optical domain allows large distances to be covered at no extra cost (especially compared to electronics), in practice light propagation among a large number of neurons on different planes requires some additional structures. Waveguiding structures or free-space optical links can be defined to collect/project light from/onto the planes. Intermediate waveguiding structures (such as optical fiber arrays) can effectively connect distant planes if the above structures can route light from a plane onto the fiber arrays instead of directly onto another plane.

In some embodiments, the invention enables something that was physically not possible before, that is analog neural networks with arbitrary neighborhoods including neighborhoods encompassing pixels on physically-distant planes.

In some embodiments, when emission and detection is done optically, the main energy cost is to convert electrons and photons and vice-versa. Optically-encoded information can be communicated via guided or free-space means over distances that would be impossible for electronic information.

In some embodiments, an application is neural processing of physically-separated inputs, for instance for stereoscopic imaging. More than two planes and sets of inputs can be at play, which can be useful for e.g. automated drones with many fields of view that are processed together. This also allows the result of neural processing occurring on one plane to be communicated to another, arbitrary processor, through, for example, a photonic link. Even on the same substrate, long-distance communication enables new tasks such as large processing neighborhoods, or separation of processing nodes and input nodes.

Computing Environment

In some aspects of the present invention, software executing the instructions provided herein may be stored on a non-transitory computer-readable medium, wherein the software performs some or all of the steps of the present invention when executed on a processor.

Aspects of the invention relate to algorithms executed in computer software. Though certain embodiments may be described as written in particular programming languages, or executed on particular operating systems or computing platforms, it is understood that the system and method of the present invention is not limited to any particular computing language, platform, or combination thereof. Software executing the algorithms described herein may be written in any programming language known in the art, compiled or interpreted, including but not limited to C, C++, C #, Objective-C, Java, JavaScript, MATLAB, Python, PHP, Perl, Ruby, or Visual Basic. It is further understood that elements of the present invention may be executed on any acceptable computing platform, including but not limited to a server, a cloud instance, a workstation, a thin client, a mobile device, an embedded microcontroller, a television, or any other suitable computing device known in the art.

Parts of this invention are described as software running on a computing device. Though software described herein may be disclosed as operating on one particular computing device (e.g. a dedicated server or a workstation), it is understood in the art that software is intrinsically portable and that most software running on a dedicated server may also be run, for the purposes of the present invention, on any of a wide range of devices including desktop or mobile devices, laptops, tablets, smartphones, watches, wearable electronics or other wireless digital/cellular phones, televisions, cloud instances, embedded microcontrollers, thin client devices, or any other suitable computing device known in the art.

Similarly, parts of this invention are described as communicating over a variety of wireless or wired computer networks. For the purposes of this invention, the words “network”, “networked”, and “networking” are understood to encompass wired Ethernet, fiber optic connections, wireless connections including any of the various 802.11 standards, cellular WAN infrastructures such as 3G, 4G/LTE, or 5G networks, Bluetooth®, Bluetooth® Low Energy (BLE) or Zigbee® communication links, or any other method by which one electronic device is capable of communicating with another. In some embodiments, elements of the networked portion of the invention may be implemented over a Virtual Private Network (VPN).

FIG. 3 and the following discussion are intended to provide a brief, general description of a suitable computing environment in which the invention may be implemented. While the invention is described above in the general context of program modules that execute in conjunction with an application program that runs on an operating system on a computer, those skilled in the art will recognize that the invention may also be implemented in combination with other program modules.

Generally, program modules include routines, programs, components, data structures, and other types of structures that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices.

FIG. 3 depicts an illustrative computer architecture for a computer 300 for practicing the various embodiments of the invention. The computer architecture shown in FIG. 3 illustrates a conventional personal computer, including a central processing unit 350 (“CPU”), a system memory 305, including a random-access memory 310 (“RAM”) and a read-only memory (“ROM”) 315, and a system bus 335 that couples the system memory 305 to the CPU 350. A basic input/output system containing the basic routines that help to transfer information between elements within the computer, such as during startup, is stored in the ROM 315. The computer 300 further includes a storage device 320 for storing an operating system 325, application/program 330, and data.

The storage device 320 is connected to the CPU 350 through a storage controller (not shown) connected to the bus 335. The storage device 320 and its associated computer-readable media, provide non-volatile storage for the computer 300. Although the description of computer-readable media contained herein refers to a storage device, such as a hard disk or CD-ROM drive, it should be appreciated by those skilled in the art that computer-readable media can be any available media that can be accessed by the computer 300.

By way of example, and not to be limiting, computer-readable media may comprise computer storage media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other medium which can be used to store the desired information and which can be accessed by the computer.

According to various embodiments of the invention, the computer 300 may operate in a networked environment using logical connections to remote computers through a network 340, such as TCP/IP network such as the Internet or an intranet. The computer 300 may connect to the network 340 through a network interface unit 345 connected to the bus 335. It should be appreciated that the network interface unit 345 may also be utilized to connect to other types of networks and remote computer systems.

The computer 300 may also include an input/output controller 355 for receiving and processing input from a number of input/output devices 360, including a keyboard, a mouse, a touchscreen, a camera, a microphone, a controller, a joystick, or other type of input device. Similarly, the input/output controller 355 may provide output to a display screen, a printer, a speaker, or other type of output device. The computer 300 can connect to the input/output device 360 via a wired connection including, but not limited to, fiber optic, ethernet, or copper wire or wireless means including, but not limited to, Bluetooth, Near-Field Communication (NFC), infrared, or other suitable wired or wireless connections.

As mentioned briefly above, a number of program modules and data files may be stored in the storage device 320 and RAM 310 of the computer 300, including an operating system 325 suitable for controlling the operation of a networked computer. The storage device 320 and RAM 310 may also store one or more applications/programs 330. In particular, the storage device 320 and RAM 310 may store an application/program 330 for providing a variety of functionalities to a user. For instance, the application/program 330 may comprise many types of programs such as a word processing application, a spreadsheet application, a desktop publishing application, a database application, a gaming application, internet browsing application, electronic mail application, messaging application, and the like. According to an embodiment of the present invention, the application/program 330 comprises a multiple functionality software application for providing word processing functionality, slide presentation functionality, spreadsheet functionality, database functionality and the like.

The computer 300 in some embodiments can include a variety of sensors 365 for monitoring the environment surrounding and the environment internal to the computer 300. These sensors 365 can include a Global Positioning System (GPS) sensor, a photosensitive sensor, a gyroscope, a magnetometer, thermometer, a proximity sensor, an accelerometer, a microphone, biometric sensor, barometer, humidity sensor, radiation sensor, or any other suitable sensor.

The following publications are each hereby incorporated herein by reference in their entirety:
1. Krizhevsky, A., Sutskever, I., & Hinton, G. E. (2012). ImageNet Classification with Deep Convolutional Neural Networks. Advances in Neural Information Processing Systems, 25.
2. LeCun, Y., Boser, B., Denker, J., Henderson, D., Howard, R., Hubbard, W., & Jackel, L. (1989). Handwritten Digit Recognition with a Back-Propagation Network. Advances in Neural Information Processing Systems, 2.
3. Wang, C.-Y., Bochkovskiy, A., & Liao, H.-Y. M. (2022). YOLOv7: Trainable bag-of-freebies sets new state-of-the-art for real-time object detectors. arXiv.org, 2207.02696.
4. L. O. Chua and L. Yang, “Cellular neural networks: applications,” in IEEE Transactions on Circuits and Systems, vol. 35, no. 10, pp. 1273-1290, Oct. 1988, doi: 10.1109/31.7601.
5. S. Taraglio and A. Zanela, “Cellular neural networks for the stereo matching problem,” 1996 Fourth IEEE International Workshop on Cellular Neural Networks and their Applications Proceedings (CNNA-96), 1996, pp. 93-98, doi: 10.1109/CNNA.1996.566499.
6. U.S. Patent Application No. 20210192330, filed Dec. 17, 2020, titled “Light-emitting Diode Neuron
7. U.S. Patent Application No. 20230157061, filed Oct. 28, 2022, titled “Reconfigurable Thin-film Photonic Filter Banks for Neuromorphic Opto-electronic Systems and Methods”

The disclosures of each and every patent, patent application, and publication cited herein are hereby incorporated herein by reference in their entirety. While this invention has been disclosed with reference to specific embodiments, it is apparent that other embodiments and variations of this invention may be devised by others skilled in the art without departing from the true spirit and scope of the invention.

What is claimed is:

1. A device, comprising:
a plurality of optically connected networked smart pixels positioned in one or more planes;
one or more imaging sensors connected to at least a portion of the smart pixels; and
wherein the device is configured to perform processing on the plane where an image is captured.

2. The device of claim 1, wherein the device is configured as a wake-up mechanism for a processor interpreting images from a camera.

3. The device of claim 2, wherein the device is configured as an event camera to determine when the processor should be energized from stand-by mode into operational mode to provide real time interpretation of the camera image.

4. The device of claim 2, wherein the device is configured to perform completed reduced readout from the camera and processing when required to reduce latency by 25% to 99.9% and power consumption by 25% to 99.9%.

5. The device of claim 1, wherein the smart pixels comprise an output configured to be conditioned by one or more received inputs, wherein the smart pixels evolve over time based on the values of other pixels the smart pixel is connected to, wherein the evolution of the smart pixels is driven by local photocurrents and other input signals, and wherein a subset of the smart pixels is reserved for non-image processing tasks.

6. The device of claim 1, wherein the device is configured to reduce the amount of readout data required by 25% to 99.9% and to reduce a time that the processor utilizes to interpret the images by 50% to 99.9%.

7. A system, comprising:
the device of claim 1; and
a computing system communicatively connected to the device, comprising the processor and a non-transitory computer-readable medium with instructions stored thereon, which when executed by the processor, perform steps comprising:
performing processing on the image plane where the image is captured.

8. A product comprising the device of claim 1, the product selected from the group consisting of a flat panel display, a curved display, a computer monitor, a computer, a medical monitor, a television, a billboard, a light for interior or exterior illumination and/or signaling, a heads-up display, a fully or partially transparent display, a flexible display, a rollable display, a foldable display, a stretchable display, a laser printer, a telephone, a mobile phone, a tablet, a phablet, a personal digital assistant (PDA), a wearable device, a laptop computer, a digital camera, a camcorder, a viewfinder, a micro-display, a 3-D display, a virtual reality or augmented reality display or device, a vehicle, a video wall comprising multiple displays tiled together, a theater or stadium screen, a light therapy device, a camera, an imaging device, and a sign.

9. A method, comprising:
providing the system of claim 7; and
performing processing on the image plane where the image is captured.

10. The method of claim 9, wherein the processing comprises local processing of data where it is acquired before readout.

11. The method of claim 9, further comprising at least one of:
offloading general processing to an external processor when a specific signature is detected; and
offloading partially processed data to reduce later processing steps the amount of data to transfer.

12. A low power video system comprising:
an edge processor; and
a camera comprising an in-plane neural network processor, configured to perform real time preprocessing of the video signal to provide a fast response time and low latency signal within 1 is to 10 ms to select when the edge processor is energized;
wherein the edge processor is in stand-by mode when not selected by the preprocessor.

13. A device, comprising:
a plurality of optically connected networked smart pixels positioned in a multiplane configuration, wherein each of the plurality of smart pixels comprises an output configured to be conditioned by one or more received inputs; and
wherein the smart pixels evolve over time based on the values of other pixels and smart nodes the smart pixel is connected to;
wherein the evolution of the smart pixels is driven by local photocurrents;
wherein the device is configured for image processing.

14. The device of claim 13, wherein the smart pixels are configured to implement different network topologies by formatting arbitrary input data as a spatially-resolved optical intensity image, and wherein non-image inputs are directly provided to the smart pixels.

15. The device of claim 13, wherein at least a portion of the smart pixels comprise light-emitting smart pixels configured to display an image, and wherein at least a portion of the smart pixels comprise optical emitters and non-planar synaptic elements.

16. A system, comprising:
the device of claim 13; and
a computing system communicatively connected to the device, comprising a processor and a non-transitory computer-readable medium with instructions stored thereon, which when executed by a processor, perform steps comprising:
performing processing of physically-separated inputs on the device;
wherein the system comprises a multiplane neural network configured to perform stereoscopic image processing or processing of images received from multiple independent cameras.

17. The system of claim 16, further comprising a cellular neural network with smart nodes on a plane, having arbitrary neighborhoods, and wherein the arbitrary neighborhoods include nearest neighbors or beyond nearest neighbors on a single plane or on different planes.

18. The system of claim 16, wherein the system is configured to perform neural processing of physically-separated inputs or optical communication links.

19. A product comprising the device of claim 13, the product selected from the group consisting of a flat panel display, a curved display, a computer monitor, a computer, a medical monitor, a television, a billboard, a light for interior or exterior illumination and/or signaling, a heads-up display, a fully or partially transparent display, a flexible display, a rollable display, a foldable display, a stretchable display, a laser printer, a telephone, a mobile phone, a tablet, a phablet, a personal digital assistant (PDA), a wearable device, a laptop computer, a digital camera, a camcorder, a viewfinder, a micro-display, a 3-D display, a virtual reality or augmented reality display or device, a vehicle, a video wall comprising multiple displays tiled together, a theater or stadium screen, a light therapy device, a camera, an imaging device, and a sign.

20. A processing method, comprising:
providing the system of claim 16; and
performing processing of physically-separated inputs.
